(19) United States
(12) Patent Application Publication
(10) Pub. No.: US 2014/0081883 A1
(43) Pub. Date: Mar. 20, 2014

(54) SYSTEMS AND METHODS FOR RECRUITING CANDIDATES FOR EMPLOYMENT

(71) Applicants: Wayne Hartman, San Antonio, TX (US); Chris Clark, Leon Valley, TX (US); Stephen Henry Holloway, San Antonio, TX (US); Michael Aaron McGlasson, Leon Valley, TX (US); Michael Myers, Leon Valley, TX (US); Ryan Edward Wyllie, Leon Valley, TX (US)

(72) Inventors: Wayne Hartman, San Antonio, TX (US); Chris Clark, Leon Valley, TX (US); Stephen Henry Holloway, San Antonio, TX (US); Michael Aaron McGlasson, Leon Valley, TX (US); Michael Myers, Leon Valley, TX (US); Ryan Edward Wyllie, Leon Valley, TX (US)

(73) Assignee: UNITED SERVICES AUTOMOBILE ASSOCIATION, San Antonio, TX (US)

(21) Appl. No.: 13/910,197

(22) Filed: Jun. 5, 2013

Related U.S. Application Data
(60) Provisional application No. 61/655,946, filed on Jun. 5, 2012.

(51) Int. Cl. G06Q 10/10

(52) U.S. Cl. CPC G06Q 10/1053
USPC 705/321

(57) ABSTRACT

An interactive computer system and method for recruiting potential employee candidates. A user interactive Graphical User Interface (GUI) is provided on a computering device connected to a network for tracking and storing an employee candidate lifecycle with a potential employer. The GUI is preferably configured and operational to provide interactive promotional materials regarding an employment opportunity with a potential employer and establish a first video conference between the candidate and at least one representative of the potential employer.

### CROSS REFERENCE TO RELATED APPLICATIONS

This application claims priority to U.S. Patent Application Ser. No. 61/655,946 filed Jun. 5, 2012 which is incorporated herein by reference in its entirety.

### FIELD OF THE INVENTION

The present invention relates to employer recruiting and staffing, and more particularly, to an interactive computer method and system for recruiting potential candidates for employment, and organizing and storing information for a lifecycle of candidate recruitment.

### BACKGROUND OF THE INVENTION

Traditionally, potential candidates for employment expend a great deal of time researching potential employers. Typically, these candidates place a great deal of importance on their job research efforts in order to identify companies that offer desirable opportunities.

Likewise, employers expend a great deal of time recruiting, e.g., identifying and researching potential candidates, and ensuring a proper match between various technical skills and personality of the potential candidates, and the employment opportunity. Recruiting efforts can typically involve initial introductions between employer representatives and potential candidates (e.g., job fairs), pre-screening interviews, initial interviews, and various follow up interviews.

Job fairs offer a traditional mix of recruitment forms, clipboards, sign-up sheets and printed pamphlets, which are used to initiate candidate interest and obtain potential candidate information regarding employment opportunities. However, such traditional recruitment techniques result in a large amount of hard-copy (e.g., paper) recruitment materials. Typically, traditional recruitment techniques require substantial organization to efficiently deliver promotional materials, and analyze potential candidate information to identify potential candidates among the large amount of materials. Moreover, candidates, in turn, may receive a bad impression regarding the employment opportunity due to the onerous and time consuming task of completing the various recruitment forms. Further still, the large amount of hard-copy materials generated from the job fair may be misplaced, or insufficiently organized and may not be placed in potential candidate files thereby leaving gaps in candidate information.

Moreover, once a candidate is selected for employment, there is typically a period of time the candidate does not hear from the company or any company representative. That is, between accepting an offer for employment to the first day of work, there remain no efficient methods that connect the candidate with additional company information, including interaction with future co-workers.

Clearly, there is a need in the art for improved systems and methods to recruit employee candidates that obviates the large amount of hard-copy recruitment materials, yet still organizes candidate information to ensure each potential candidate file is complete. Further, a need remains for dynamically interactive systems and methods that efficiently disseminate promotional material to potential candidates and obviate the onerous task of completing recruitment forms. Further still, a need remains to connect a selected candidates with additional company information, including interaction with future co-workers between the time periods of accepting an offer for employment to the first day of work.

### SUMMARY OF THE INVENTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, an interactive computer system and method for recruiting potential employee candidates is described in which a user interactive Graphical User Interface (GUI) is provided on a computering device preferably connected to a network for tracking and storing an employee candidate lifecycle with a potential employer. The GUI is preferably configured and operational to provide interactive promotional materials regarding an employment opportunity with a potential employer and receive electronic candidate information from an employee candidate for the employment opportunity. The GUI is further configured and operational to enable a request for a first video conference between the candidate and at least one representative of the potential employer and establish a first video conference between the candidate and at least one representative of the potential employer at least in response to the received electronic candidate information.

Additional aspects of the invention include identifying, via the GUI, at least one future co-worker of the candidate after a valid determination to hire the candidate, and providing the at least one future co-worker access to communicate with future co-workers the candidate is determined to work with after a valid determination to hire the candidate.

Further aspects may include, via the GUI, receiving a request for a second video conference between the candidate and the identified future co-worker and connecting the candidate and the future co-worker via the second video conference in response to the request for the second video conference.

### BRIEF DESCRIPTION OF THE DRAWINGS

So that those having ordinary skill in the art, to which the present invention pertains, will more readily understand how to employ the novel system and methods of the present invention, certain illustrated embodiments thereof will be described in detail herein-below with reference to the drawings, wherein:

FIG. 1 is a system diagram of s computer configured and operations for executing interactive recruitment methods;

FIG. 2 illustrates a screen shot of an initial home display screen generated by the computer of FIG. 1;

FIG. 3 illustrates a screen shot of a subsequent careers screen generated by the computer of FIG. 1;

FIG. 4 illustrates a screen shot of a subsequent promotional material screen generated by the computer of FIG. 1;

FIG. 5 illustrates a screen shot of a subsequent video screen generated by the computer of FIG. 1;

FIG. 6 illustrates a screen shot of a subsequent display news publication screen generated by the computer of FIG. 1; and

FIG. 7 illustrates a screen shot of a subsequent business card screen generated by the computer of FIG. 1.

### DETAILED DESCRIPTION OF CERTAIN EMBODIMENTS

The present disclosure is directed to systems and methods for recruiting employee candidates as described in the below illustrated embodiments. More particularly, the subject invention is directed to providing dynamically interactive systems and methods that efficiently disseminate promotional materials to potential candidates and obviate the onerous task of completing recruitment forms. It is to be appreciated the subject invention is described below more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention. A component or a feature that is common to more than one drawing is indicated with the same reference number in each of the drawings.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program. As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

As discussed above, the traditional recruitment methods typically involve cumbersome hard-copy materials. However, technology advances in portable consumer electronic devices now serve to displace these traditional hard-copy printed materials. For example, electronic devices such as laptops, tablet computing devices, e-readers, and smart phones, are typically enabled to read electronic copies of traditionally printed materials. Moreover, these technology advances new provide opportunities to dynamically and interactively communicate with potential candidates regarding employment opportunities.

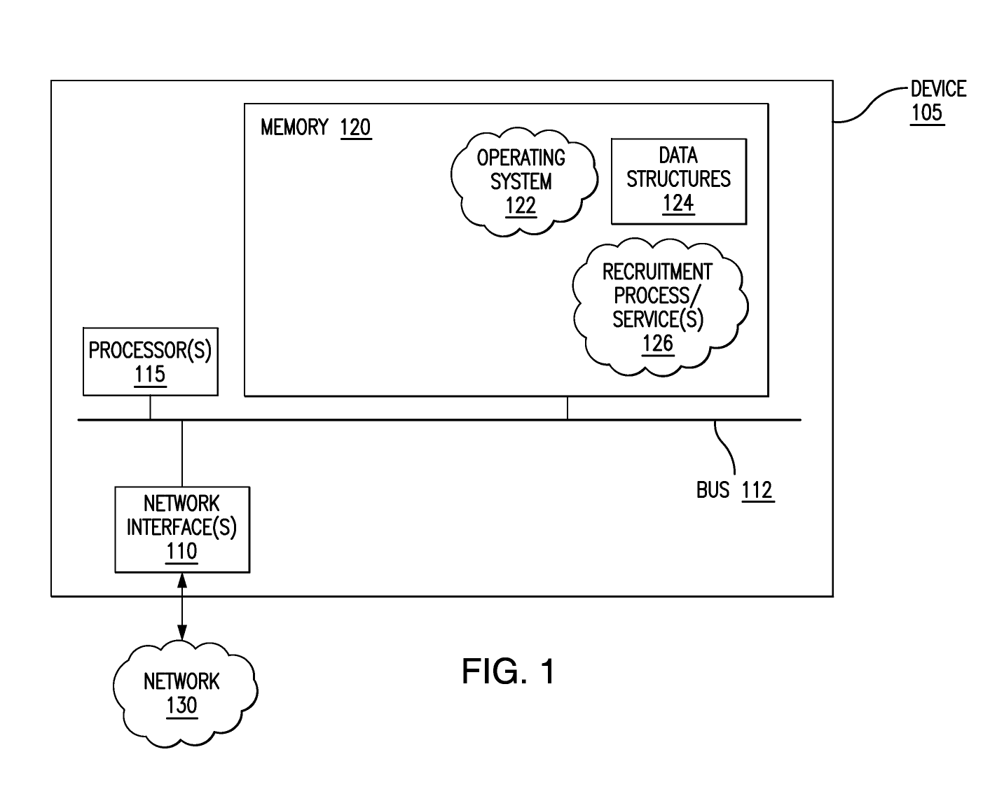

Referring to the FIGS, and in particular FIG. 1, there is provided a diagram of a system, i.e., system 100, for aggregating and disseminating materials regarding a company including job opportunities.

System 100 includes a device 105 (e.g., a computer) coupled to a network 130, e.g., the Internet. Device 105 includes an interface 110, a processor 115, and a memory 120. Although device 105 is represented herein as a standalone device, it is not limited to such, but instead can be coupled to other devices (not shown) in a distributed processing system.

Interface 110 can include the mechanical, electrical, and signaling circuitry for communicating data over network 130. Interface 110 may be configured to transmit and/or receive data using a variety of different communication protocols and various network connections, e.g., wireless and wired/physical connections. However, it should be noted that the view used herein is merely for illustration. Interface 110 can further include an input device, such as a keyboard, a touch screen or a speech recognition subsystem, which enables a user (e.g., a candidate) to communicate information and command selections to processor 115. Interface 110 can also includes an output device such as a display screen. Interface 110 can further include an input device such as a touch screen, a mouse, track-ball, or joy stick, which allows the user to manipulate the display for communicating additional information and command selections to processor 115.

Memory 120 includes a plurality of storage locations that are addressable by the processor 115 and the interfaces 110 (via a bus 112) for storing software programs and data structures associated with the embodiments described herein. Processor 115 is an electronic device configured of logic circuitry that responds to and executes instructions and may include hardware elements or hardware logic adapted to execute the software programs and manipulate the data structures 124.

An operating system 122, portions of which is typically resident in memory 122 and executed by processor 115, functionally organizes the device by, inter alia, invoking operations in support of software processes and/or services executing on the device. These software processes and/or services may comprise recruitment process/services 126, as described herein. Note that while processes 126 are shown in centralized memory 120, additional embodiments provide for either of the processes to be specifically operated over network 130 via interface 110. For example, the recruitment process/services 126, when executed by processor 115, can cause the processor to preferably provide promotional materials regarding a company to a candidate including at least a virtual tour of the company and receive candidate information from the candidate. In response to the candidate information recruitment process/services 126 can send the candidate a message or notification indicating safe receipt. In addition, recruitment process/services 126 can cause the processor to further receive a request for a first video conference between the candidate and at least one company representative; connect the candidate and the company representative via the first video conference (in response to the request); identify at least one future co-worker of the candidate after a valid determination to hire the candidate; receive a request for a second video conference between the candidate and the identified future co-worker; and connect the candidate and the future co-worker via the second video conference (in response to the request).

Note further that while process 126 is shown as installed in a memory 240, and therefore being implemented in software, these processes could be implemented in any of hardware (e.g., electronic circuitry), firmware, software, or a combination thereof. For instance, process 126 may be may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, tablet devices, smart phone devices, multiprocessor systems, microprocessor-based systems, set top boxes, programmable consumer electronics, network, minicomputers, server computers, game server computers, web server computers, mainframe computers, and distributed computing environments that include any of the above systems or devices.

Alternatively, these processes may be configured on a storage medium for subsequent loading into memory 120. The storage medium can include a computer-readable medium encoded with a computer program, and can be any conventional storage medium that stores the processes thereon in tangible form. Examples of storage media include a floppy disk, a compact disk, a magnetic tape, a read only memory, an optical storage media, universal serial bus (USB) flash drive, etc. Alternatively, storage media can include a random access memory, or other type of electronic storage, located on a remote storage system and coupled to processor 115, via interface 110.

A component or a feature that is common to more than one drawing is indicated with the same reference number in each of the drawings. As will be apparent to those skilled in the art other processor and memory types, including various computer-readable media, may be used to store and execute program instructions pertaining to the techniques described herein.

Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

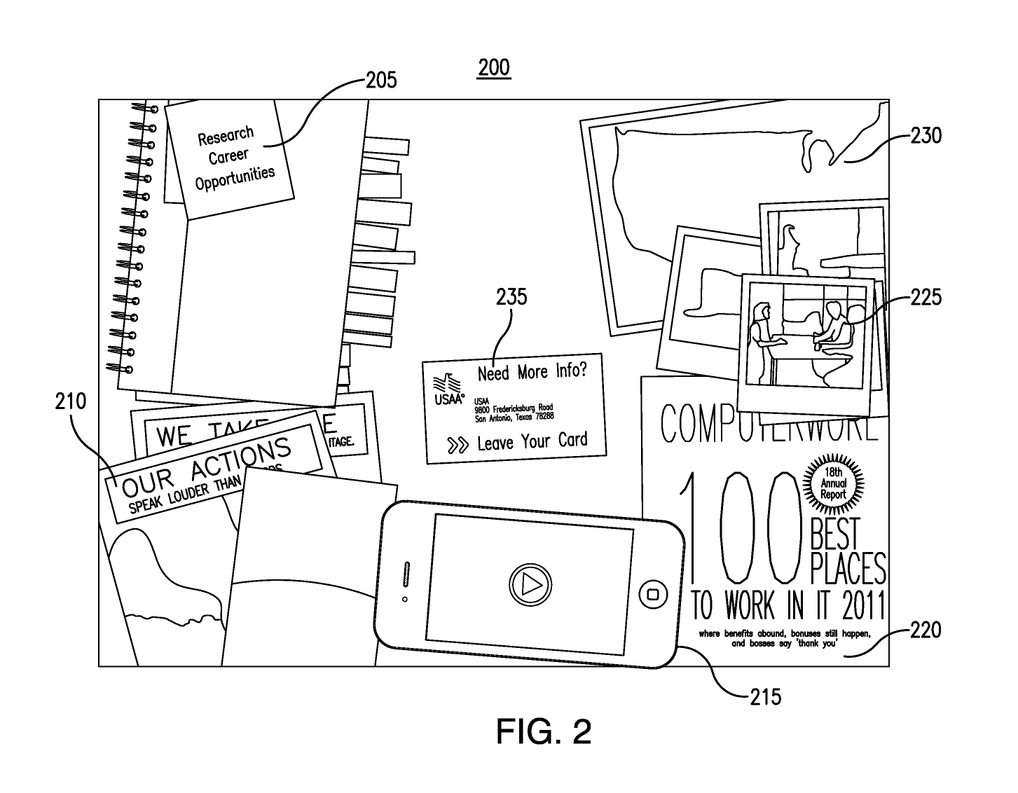

Collectively FIGS. 2-7 illustrate various screen shots, preferably generated on a Graphical User Interface (GUI), regarding execution of recruitment process 126 by device 105. For purposes of discussion, device 105 typically receives candidate input that selects various interactive elements, which cause the processor to further display additional screens, store candidate-entered information, and generally execute candidate commands, as discussed below. It is noted FIGS. 2-7 are shown in regards to a device 105 configured as a tablet device for ease of illustration purposes only and device 105 is not to be understood to be limited to a tablet device as it may encompass any user computering device suitable for use with the illustrated embodiments described herein.

FIG. 2 illustrates a screen shot of an initial home display screen 200, according to one or more embodiments of the invention discussed herein.

In particular, home display screen 200 provides for various interactive elements including, but not limited to: research career opportunities 205, promotional materials 210 (e.g. “our actions” and “who we are”), a video player 215 (e.g., a smart phone), news publications 220, pictures 225, a geographic map 230, and a business card 235. Home display screen 200 is preferably generated and displayed by device 105 of FIG. 1. Moreover, each of the interactive elements, once selected can cause the processor 115 to further execute processes to display additional other screens and/or store user commands (e.g., candidate input of text), as described herein.

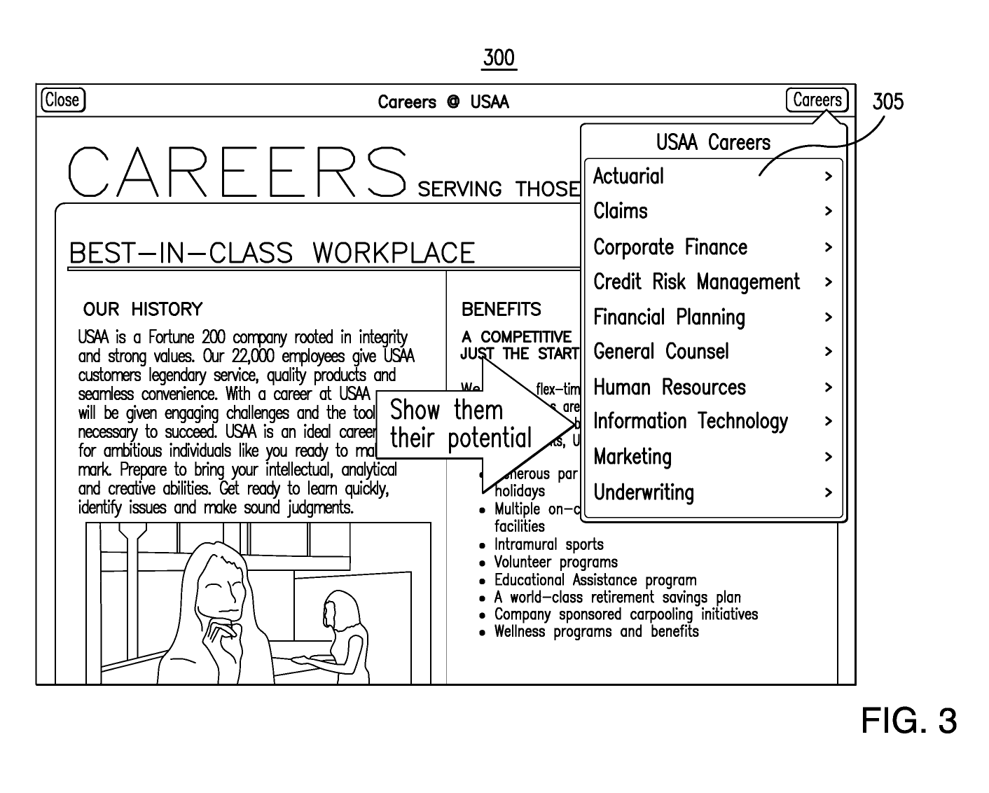

FIG. 3 illustrates a screen shot of a subsequent careers screen 300, following interaction with interactive element 205 (e.g., “research career opportunities”)(FIG. 2). That is, device 105 receives user input that selects interactive element 205, which causes the processor to further display home screen 300.

Careers screen 300 provides information regarding careers and, in particular, careers according to particular departments. The careers menu 305, in other embodiments, can be arranged according to other categories such as, but not limited to industries. The candidate can interact and select one of the departments displayed by the careers menu 305 and cause the processor to display additional information regarding opportunities in the corresponding department. Notably, a backdrop of careers screen 300 includes information for the candidate that discusses a history of the company as well as highlights of benefits of working in the company.

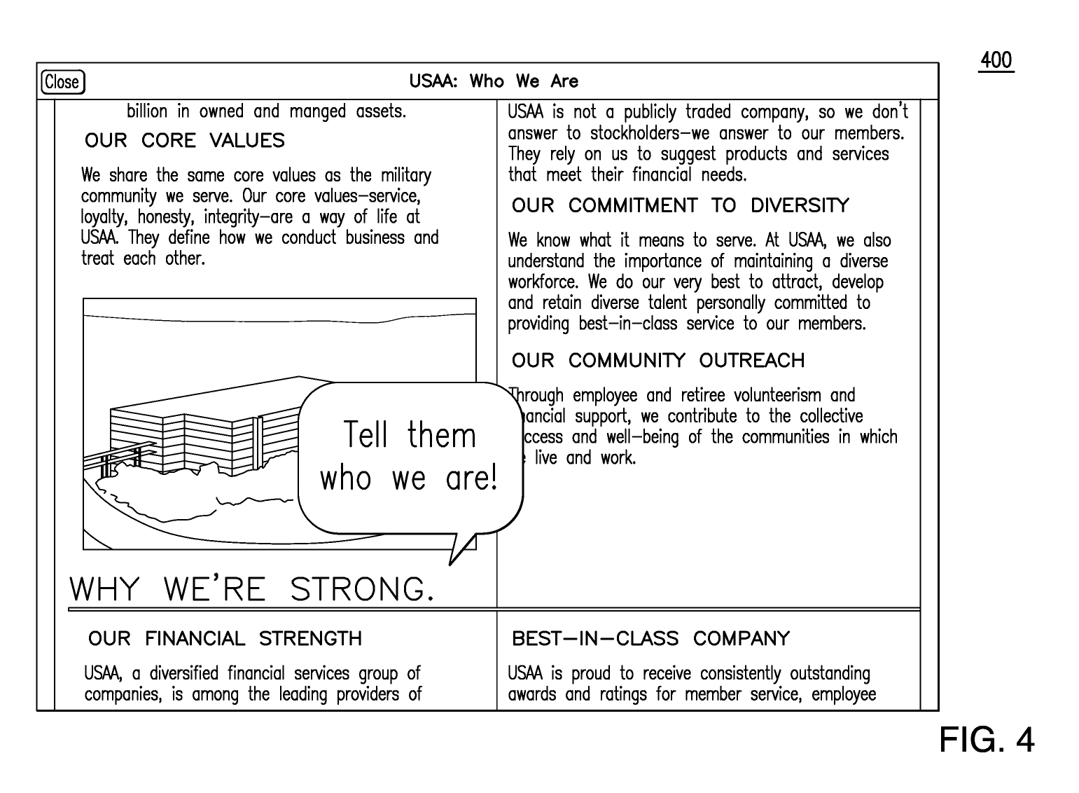

FIG. 4 illustrates a screen shot of a subsequent promotional material screen 400, following interaction with interactive element 210 (e.g., promotional materials, which include “our actions” and “who we are”). That is, device 105 receives user input that selects interactive element 210, which causes the processor 115 to further display promotional material screen 400.

Promotional material screen 400 provides information regarding highlights of the company. For example, highlights can include core values, diversity, community outreach, financial strength, best-in-class, etc. The promotional material can provide the candidate additional promotional information about the company.

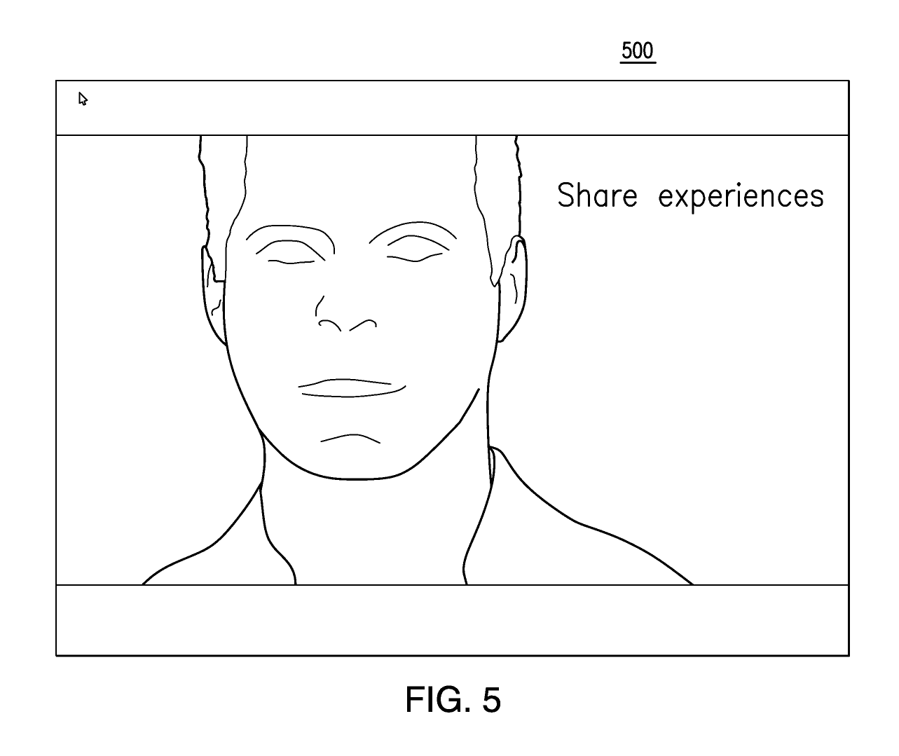

FIG. 5 illustrates a screen shot of a subsequent video screen 500, following interaction with interactive element 215 (e.g., “video player 215”). That is, device 105 receives user input that selects interactive element 215, which causes the processor to further video screen 500.

In an illustrated embodiment, video screen 500 preferably provides a multimedia display of video from a current employee of the company. The video can include short video segments of various other employees, a virtual tour of the company, or other video segments providing additional company information. Video screen 500 can further provide interactive controls (not illustrated) to allow a candidate to input various commands such as fast forward, rewind, pause, next, go-back, etc.

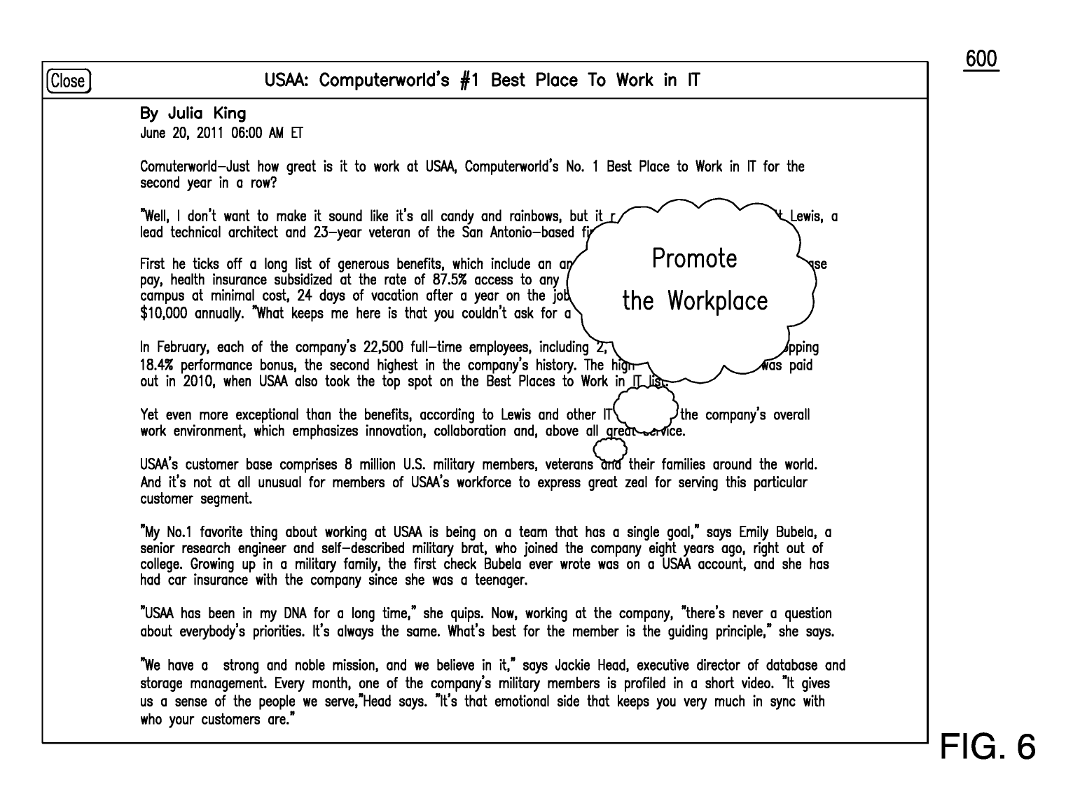

FIG. 6 illustrates a screen shot of a subsequent display news publication screen 600, following interaction with interactive element 220 (e.g., “news publications”). That is, device 105 receives user input that selects interactive element 220, which causes the processor to further display news publication screen 600.

News publication screen 600 provides articles regarding the company. These articles can include recent online publications, blog entries, internal company written articles, etc. In some embodiments news publication screen 600 lists the various articles and publications regarding the company, which can be organized according to date, topic, author, etc. The candidate can select a desired article and cause the processor to retrieve and display the article.

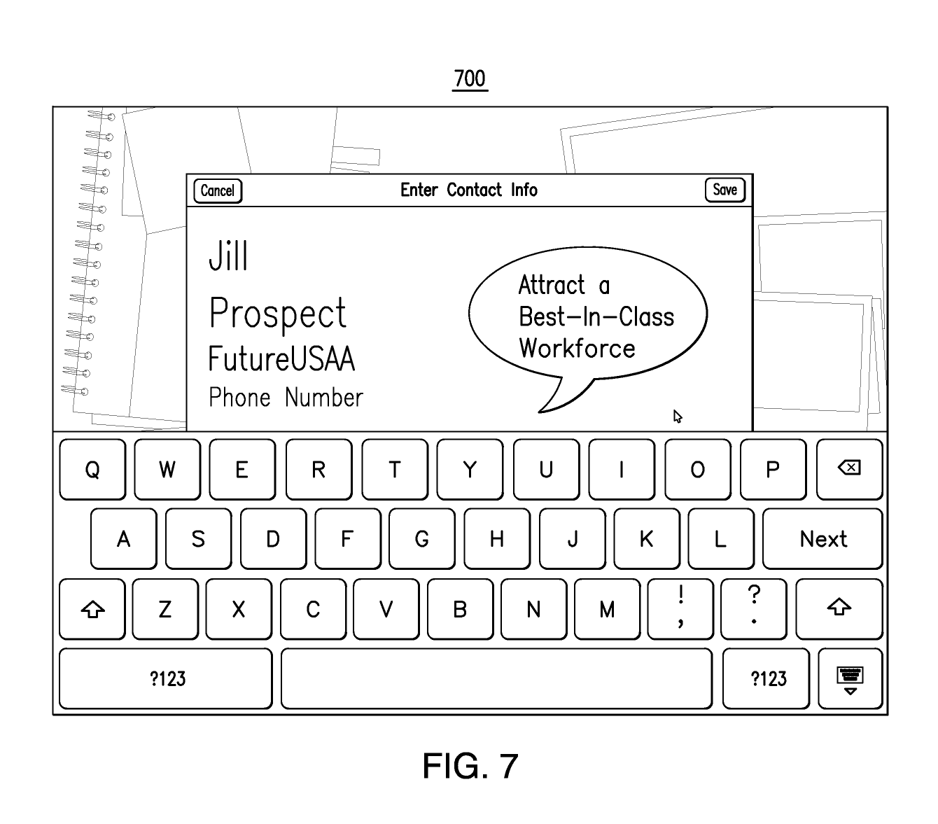

FIG. 7 illustrates a screen shot of a subsequent business card screen 700, following interaction with interactive element 235 (e.g., “the business card”). That is, device 105 receives user input that selects interactive element 235, which causes the processor to further display business card screen 700.

Business card screen 700 provides an electronic business card with candidate-filled text fields. For example, these fields can include contact information about the candidate such as a name, an email address, a mailing address, a phone number, etc. The candidate can further save the information, which can cause the processor to store the information and/or submit the information for additional processing. In some embodiments, a profile for a candidate can be built for the candidate, based on the stored electronic business card. In this fashion, the candidate can fill out an electronic recruitment form, which obviates the need of the onerous task of manually filling out hard-copies. In additional embodiments, device 105 includes a camera that can image a hard-copy business card, perform optical character recognition, and upload information into the text fields illustrated in business card screen 700. In other embodiments, the candidate can submit the business card, once completed, and receive a text notification message (e.g., a short message service (SMS) message, a multimedia message service (MMS) message, an email, etc.) that the business card has been submitted.

As discussed above, FIGS. 2-7 collectively illustrate various screen shots of execution of recruitment process 126 by device 105 in accordance with certain illustrated embodiments. These various screen shots illustrate how recruitment process 126 provides a dynamically interactive system and method that efficiently disseminates promotional material to potential candidates (e.g., users), and obviates the onerous task of completing recruitment forms. Further, the electronic organization of materials efficiently organizes promotional material, as well as organizes candidate stored information for further consideration.

Notably, interactive element 230, i.e., the geographic map, was not illustrated in a subsequent display screen. When the geographic map is selected, the processor displays an enlarged geographic map that identifies office locations. These office locations can also be interactive elements, which, when selected cause the processor to display additional office location specific information to the candidate.

In some embodiments, the recruitment process can include an online interview. In these embodiments, the computer, which executes the recruitment process, allows the user to communicate with a representative of the company online (e.g., video conferencing). The interview can include pre-screening interviews, follow up interviews, and general discussion with various company representatives. These interviews can further be stored by the device for subsequent access. In addition, once a candidate has been selected for employment, the candidate can conference with future co-workers. In this fashion, the future co-workers can connect with and get to know the candidate prior to initial employment date.

In other embodiments, the recruitment process/services can allow the candidate to upload candidate-generated content (e.g., resumes, cover letters, questions, etc.), which can be later accessed by a company representative (e.g., a Human Resources employee) for further consideration.

Further still, in some embodiments, candidates, once selected, can be granted access to view and interact with additional company information such as local recommended places to eat, people that will work on the same team as the future employee, etc.

Accordingly, the present invention provides interactive multimedia access to company materials and can provide efficient candidate tracking of candidate materials, and the lifecycle of interviewing.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

Although the systems and methods of the subject invention have been described with respect to the embodiments disclosed above, those skilled in the art will readily appreciate that changes and modifications may be made thereto without departing from the spirit and scope of the subject invention as defined by the appended claims.

What is claimed is:

1. A computer implemented method comprising:
providing a user interactive Graphical User Interface (GUI) on a computering device connected to a network for tracking and storing an employee candidate lifecycle with a potential employer, the GUI configured and operational to:
provide interactive promotional materials regarding an employment opportunity with a potential employer;
receive electronic candidate information from an employee candidate for the employment opportunity;
enable a request for a first video conference between the candidate and at least one representative of the potential employer; and
establish a first video conference between the candidate and at least one representative of the potential employer at least in response to the received electronic candidate information.

2. A computer implemented method as recited in claim 1 further including identifying, via the GUI, at least one future co-worker of the candidate after a valid determination to hire the candidate.

3. A computer implemented method as recited in claim 2 further including, via the GUI, providing the at least one future co-worker access to communicate with future co-workers the candidate is determined to work with after a valid determination to hire the candidate.

4. A computer implemented method as recited in claim 2 further including:
receiving a request for a second video conference between the candidate and the identified future co-worker; and
connecting the candidate and the future co-worker via the second video conference in response to the request for the second video conference.

5. A computer implemented method as recited in claim 1 wherein establishing a first video conference includes:
providing pre-screening employment interviews for the candidate; and
providing electronic discussion between the candidate and a plural of current employees after a video interview for the employment opportunity.

6. A computer implemented method as recited in claim 1 wherein the first video conference is electronically stored for subsequent retrieval.

7. A computer implemented method as recited in claim 1 wherein receiving electronic candidate information includes using a camera device associated with the GUI to image textual information provided by the candidate.

8. A computer implemented method as recited in claim 2, wherein the identifying at least one future co-worker comprises:
determining a department the candidate is assigned; and
identifying the at least one future co-worker from the department.

9. An apparatus for candidate lifecycle tracking comprising:
a processor; and
a memory that contains instructions that are readable by said processor and cause said processor to:
provide promotional materials regarding a company to a candidate including at least a virtual tour of the company;
receive candidate information from the candidate;
send a message to the candidate in response to receiving the candidate information;
receive a request for a first video conference between the candidate and at least one company representative;
connect the candidate and the company representative via the first video conference in response to the request for the first video conference;
identify at least one future co-worker of the candidate after a valid determination to hire the candidate;
receive a request for a second video conference between the candidate and the identified future co-worker; and
connect the candidate and the future co-worker via the second video conference in response to the request for the second video conference.

10. An apparatus as recited in claim 9, wherein the identifying at least one future co-worker comprises:
determining a department the candidate is assigned; and
identifying the at least one future co-worker from the department.

11. An apparatus as recited in claim 9, wherein the message is one selected from the group consisting of: a short message service (SMS) message, a Multimedia Messaging Service (MMS) message, and an email.

12. An apparatus as recited in claim 9, wherein establishing a first video conference includes:
providing pre-screening employment interviews for the candidate; and
providing electronic discussion between the candidate and a plural of current employees after a video interview for the employment opportunity.

13. A non-transitory computer readable storage medium and one or more computer programs embedded therein, the computer programs comprising instructions, which when executed by a computer system, cause the computer system to:
provide a user interactive Graphical User Interface (GUI) on a computering device connected to a network for tracking and storing an employee candidate lifecycle with a potential employer, the GUI configured and operational to:
provide interactive promotional materials regarding an employment opportunity with a potential employer;
receive electronic candidate information from an employee candidate for the employment opportunity;
enable a request for a first video conference between the candidate and at least one representative of the potential employer; and
establish a first video conference between the candidate and at least one representative of the potential employer at least in response to the received electronic candidate information.

14. A non-transitory computer readable storage medium as recited in claim 13 wherein the computer programs further cause the computer to identify, via the GUI, at least one future co-worker of the candidate after a valid determination to hire the candidate.

15. A non-transitory computer readable storage medium as recited in claim 14 wherein the computer programs further cause the computer to, via the GUI, provide the at least one future co-worker access to communicate with future co-workers the candidate is determined to work with after a valid determination to hire the candidate.

16. A non-transitory computer readable storage medium as recited in claim 14 wherein the computer programs further cause the computer to:
receive a request for a second video conference between the candidate and the identified future co-worker; and
connect the candidate and the future co-worker via the second video conference in response to the request for the second video conference.

17. A non-transitory computer readable storage medium as recited in claim 14 wherein establishing a first video conference includes:
providing pre-screening employment interviews for the candidate; and
providing electronic discussion between the candidate and a plural of current employees after a video interview for the employment opportunity.

18. A non-transitory computer readable storage medium as recited in claim 13 wherein the first video conference is electronically stored for subsequent retrieval.

19. A non-transitory computer readable storage medium as recited in claim 13 wherein receiving electronic candidate information includes using a camera device associated with the GUI to image textual information provided by the candidate.

20. A non-transitory computer readable storage medium as recited in claim 14, wherein the identifying at least one future co-worker comprises:
determining a department the candidate is assigned; and
identifying the at least one future co-worker from the department.
